(19) United States
(12) Patent Application Publication
(10) Pub. No.: US 2014/0099693 A1
(43) Pub. Date: Apr. 10, 2014

(54) HIGH CONCENTRATION H2S ELIMINATION SYSTEM AND HIGH CONCENTRATION H2S ELIMINATION METHOD

(71) Applicant: National Chiao Tung University, Hsinchu City (TW)

(72) Inventors: Ching-Ping TSENG, Hsinchu City (TW); Wei-Chih LIN, New Taipei City (TW)

(73) Assignee: National Chiao Tung University, Hsinchu City (TW)

(21) Appl. No.: 14/022,870

(22) Filed: Sep. 10, 2013

(30) Foreign Application Priority Data
Oct. 8, 2012 (TW) 101137074

(51) Int. Cl. B01D 53/96

(52) U.S. Cl. CPC B01D 53/96
USPC 435/174; 435/294.1; 435/266

(57) ABSTRACT

A high concentration H₂S elimination system and a method using the same are disclosed. The system of the present invention comprises: a chemical H₂S elimination module with a gas inlet, a gas outlet and a liquid outlet, wherein H₂ S-containing gas is introduced into the chemical H₂S elimination module; a reagent storage unit containing an oxidant; a liquid spray unit, wherein the oxidant contained in the reagent storage unit is introduced into the chemical H₂S elimination module from the liquid inlet thereof through the liquid spray unit; a bio-regeneration unit comprising a microorganism to regenerate oxidant and connecting to the reagent storage unit; and a sulfur-removing module connecting to the liquid outlet of the chemical H₂S elimination module.

### CROSS REFERENCE TO RELATED APPLICATION

This application claims the benefits of the Taiwan Patent Application Serial Number 101137074, filed on Oct. 8, 2012, the subject matter of which is incorporated herein by reference.

### BACKGROUND OF THE INVENTION

1. Field of the Invention

The present invention relates to a high concentration H₂S elimination system and a high concentration H₂S elimination method and, more particularly, to a high concentration H₂S elimination system and a high concentration H₂S elimination method using the same that the used oxidant can be regenerated and recycled.

2. Description of Related Art

H₂S gas is one common pollutant gas, and H₂S-containing gas with different H₂S concentration is generated in various industrial processes. For example, the H₂S concentration of H₂S-containing gas is about 1000 ppm in a landfill; the H₂S concentration of marsh gas generated in an anaerobic wastewater treatment plant is about 3000 ppm-10000 ppm; and pollutant gas containing several tens of thousands of ppm of H₂S is generated in leather industries, paper industries, or oil refining industries. This high concentration H₂S-containing gas causes machines eroded, and is also harmful to health.

In order to reduce the harm caused by the H₂S-containing gas, several H₂S elimination methods have been developed, such as physical treatments, incinerations, Claus methods, chemical rinsing techniques and bio-treatments. However, these methods still have their limitation. For example, although the physical treatments have advantages of high-removing rate, short processing time and long operation period, secondary pollutions may be generated and the regeneration cost is high. The bio-treatments have advantages of low energy consuming and low cost, and do not cause secondary pollutions, but the H₂S concentration that the microorganism can endure is still has its upper limits. In addition, in the case that the Claus methods are used with amine absorptions to eliminate H₂S in the H₂S-containing gas, the used instruments are expensive and the processes thereof are complicated though H₂S can be effectively removed.

Since H₂S-containing gas with high H₂S concentration is usually observed in the industrial waste gas, it is desirable to provide a novel high concentration H₂S elimination system and method that can solve the aforementioned disadvantages and have advantages of high efficiency, low cost, simple operation and regeneration of oxidant; therefore, these novel system and method can be applied to various industries that require eliminating H₂S.

### SUMMARY OF THE INVENTION

The object of the present invention is to provide a high concentration H₂S elimination system and a high concentration H₂S elimination method, wherein the oxidant used to treat the high concentration H₂S gas can be regenerated with an organism, and therefore the purpose of high efficiency, low cost, simple operation, regeneration and recycling can be accomplished in the system and the method of the present invention.

To achieve the object, the high concentration H₂S elimination system of the present invention comprises: a chemical H₂S elimination module with a gas inlet, a gas outlet and a liquid outlet, wherein H₂S-containing gas is introduced into the chemical H₂S elimination module from the gas inlet; a reagent storage unit containing an oxidant, which can be any reagent with oxidation capability such as a Fe³⁺-containing solution, a Mn⁴⁺-containing solution, or a combination thereof; a liquid spray unit, wherein the oxidant contained in the reagent storage unit is introduced into the chemical H₂S elimination module from the liquid inlet thereof through the liquid spray unit; a bio-regeneration unit comprising an organism to regenerate a reduced reagent into the oxidant and connecting to the reagent storage unit; and a sulfur-removing module connecting to the liquid outlet of the chemical H₂S elimination module.

In addition, the present invention further provides a high concentration H₂S elimination method, which can be operated with the aforementioned system, comprising the following steps: (A) introducing H₂S-containing gas into a chemical H₂S elimination module, and introducing an oxidant contained in a reagent storage unit into the chemical H₂S elimination module with a liquid spray unit to react H₂S in the H₂S-containing gas with the oxidant to obtain a reduced reagent and H₂S-removing gas, wherein the H₂S-removing gas is exhausted from the chemical H₂S elimination module, the reduced reagent is exhausted into a sulfur-removing module or exhausted into a reagent storage unit and then introduced into the sulfur-removing module, and the oxidant is a Fe³⁺-containing solution, a Mn⁴⁺-containing solution, or a combination thereof; (B) removing sulfur solids in the reduced reagent via the sulfur-removing module, and then introducing the reduced reagent without the sulfur solids into a bio-regeneration unit, wherein the bio-regeneration unit comprises an organism to regenerate the reduced reagent without the sulfur solids into the oxidant; and (C) recycling and introducing the oxidant regenerated by the organism into the reagent storage unit.

According to the aforementioned system and method of the present invention, when the H₂S-containing gas is introduced into the chemical H₂S elimination module via the gas inlet thereof, the oxidant contained in a reagent storage unit is simultaneously introduced into the chemical H₂S elimination module with the liquid spray unit, and the introduced H₂S-containing gas can be reacted with the oxidant in the chemical H₂S elimination module to obtain a reduced reagent and H₂S-removing gas. Then, the obtained H₂S-removing gas is exhausted via the gas outlet of the chemical H₂S elimination module, and the obtained reduced reagent is exhausted via the liquid outlet thereof into the sulfur-removing module to remove sulfur solids in the reduced reagent. Herein, the sulfur solids in the reduced reagent is firstly removed and then the reduced reagent substantively without the sulfur solids contained therein is introduced into the bio-regeneration unit, so the H₂S removing efficiency can be improved, and the lifetime of the bio-regeneration unit can further be elongated. After the sulfur solids are removed by the sulfur-removing module, the reduced reagent without the sulfur solids is introduced into the bio-regeneration unit. The organism to regenerate the oxidant in the bio-regeneration unit can oxidize the introduced reduced reagent into the oxidant in the original oxidation state, and then the oxidant in the oxidation state is recycled and introduced into the reagent storage unit. Hence, the method and the system of the present invention can accomplish the purpose of recycling and reusing the oxidant, and prevent the pollution caused by the oxidant after the sulfur reduction reaction.

In particular, in the system and the method of the present invention, the H₂S-containing gas contacts with a spray of the oxidant in the chemical H₂S elimination module. Compared to the conventional chemical H₂S elimination module filled with a mixture of a support and an oxidant, the sprayed oxidant can mix well with the H₂S-containing gas, so that the reaction between the H₂S-containing gas and the oxidant can be performed more completely. In addition, the total surface area of the spayed oxidant in the present invention is larger than that in the conventional chemical H₂S elimination module, so the efficiency of H₂S elimination of the present invention can further be enhanced.

In the present invention, the chemical H₂S elimination module comprises at least one H₂S elimination column, and preferably plural H₂S elimination columns connecting with each other in series or in parallel. Except that the number of the H₂S elimination columns can be adjusted, the spraying direction of the liquid spray unit can also be altered. In the present invention, the spraying direction of the liquid spray unit is not particularly limited, and the liquid spray unit can spray the oxidant from a top end or a lateral side of the chemical H₂S elimination module. More specifically, the liquid spray unit can spray the oxidant from the top end of the chemical H₂S elimination module and along with the flow direction of the oxidant. Alternatively, the liquid spray unit can spray the oxidant from the lateral side of the chemical H₂S elimination module, wherein an angle is included between the spraying direction of the liquid spray unit and the flow direction of the oxidant.

It should be noted that the chemical H₂S elimination module used in the present invention preferably is an empty tank, not a filled tank. In the conventional chemical H₂S elimination module filled with a mixture of a support and an oxidant, it may be difficult to introduce the H₂S-containing gas from the bottom thereof due to the large pressure drop thereof. This problem may be getting severe in the case that the chemical H₂S elimination module is long, the amount of the H₂S-containing gas is increased, or the concentration of H₂S is high. In addition, the sulfur solids formed in the conventional chemical H₂S elimination module may block the gas between support particles, the gas inlet/outlet and the liquid inlet/outlet of the chemical H₂S elimination module, so the module has to be disassembled and cleaned periodically to maintain the performance of the conventional system. However, since the chemical H₂S elimination module used in the present invention is an empty tank, the suffer solids formed by the reaction between the H₂S-containing gas and the oxidant can be introduced into the sulfur-removing module, and do not block the inlets and outlets of the chemical H₂S elimination module.

In the present invention, the sulfur-removing module is provided to remove the sulfur solids generated in the chemical H₂S elimination module, and the disposition thereof is not particularly limited, as long as the sulfur-removing module is disposed between the chemical H₂S elimination module and the bio-regeneration unit. For example, the sulfur-removing module may be disposed between the reagent storage unit and the bio-regeneration unit, so the reduced reagent generated in the chemical H₂S elimination module may be firstly introduced into the reagent storage unit, and then into the sulfur-removing module to perform the process of removing the sulfur solids. Alternatively, the sulfur-removing module may be disposed between the chemical H₂S elimination module and the reagent storage unit, so the reduced reagent generated in the chemical H₂S elimination module may be firstly introduced into the sulfur-removing module to remove the sulfur solids contained therein, and then into the reagent storage unit. Preferably, the sulfur-removing module is disposed between the chemical H₂S elimination module and the reagent storage unit.

Furthermore, in the system and the method of the present invention, the number of the H₂S elimination columns is not particularly limited, and can be adjusted according to the concentration of H₂S in the H₂S-containing gas. Hence, the method and the system of the present invention can be used to treat the H₂S-containing gas with 1000 ppm or more of H₂S. In particular, the H₂S-removing rate is almost 100% when the concentration of H₂S in the H₂S-containing gas is 1000-2000 ppm; the H₂S-removing rate is around 97% when the concentration of H₂S in the H₂S-containing gas is 3000-4000 ppm; and the H₂S-removing rate is around 95% when the concentration of H2S in the H2S-containing gas is 4000-5000 ppm.

In the high concentration H₂S elimination system of the present invention, the sulfur-removing module may comprise a sulfur filtration unit, and a sulfur-removing unit. The sulfur filtration unit can separate the sulfur solids from the reduced reagent via a precipitation means or an interception means, and the separated sulfur solids can be removed from the system by the sulfur-removing unit. Herein, the sulfur filtration unit can be a container made of glass, acrylic, plastic or other material, and selectively filled with a support such as glass beads, porphyritic andesite, filter films and other solids. The shape of the support is not particularly limited, and can be particles, rods, sheets or other shapes.

In the high concentration H₂S elimination system of the present invention, the organism to regenerate the oxidant is not particularly limited, and can be any microorganism or enzyme which is capable of regenerating and oxidizing the reduced reagent into the oxidant. For example, when the oxidant is a Fe³⁺-containing solution, the organism can be a microorganism or an enzyme that can oxidize the formed Fe²⁺ ions into Fe³⁺ ions after the H₂S elimination reaction. Herein, examples of the organism used in the present invention comprise, but not limite to: Acidithiobacillus ferrooxidans (GenBank No. AF362022), Leptospirillum ferriphilum (GenBank No. JF510470), Acidithiobacillus ferrooxidans (GenBank No. JN224813), Sulfobacillus sp. L15 (GenBank No. AY007663), and Sulfobacillus thermosulfidooxidans (GenBank No. EU499919).

In the system and the method of the present invention, the bio-regeneration unit can be any container made of glass, acrylic, plastic or other material, and the exterior of the container may have temperature controllable double-layer structure. In addition, the bio-regeneration unit may be selectively filled with a liquid medium with the organism suspending therein; or a support with the organism adhered thereon or embedded therein. p Furthermore, in the system and the method of the present invention, a pump may be selectively disposed in front of the chemical H₂S elimination module, between the reagent storage unit and the liquid spray unit, between the bio-regeneration unit and the reagent storage unit, or between the sulfur-removing module and the bio-regeneration unit, in order to facilitate the flow of gas or liquid.

In addition, in the system and the method of the present invention, the gas outlet of the chemical H₂S elimination module may connect with a power generator. Hence, the H₂S-removing gas exhausted from the chemical H₂S elimination module can be introduced into the power generator to achieve the purpose of renewable energy.

Furthermore, in the system and the method of the present invention, the flow rate or the flow amount of the H₂S-containing gas is not particularly limited. However, the conventional device for controlling the flow rate or the flow amount of introducing gas may also be used in the system of the present invention. For example, the H₂S-containing gas may be introduced into the chemical H₂S elimination module via a gas compressor (for example, a blower or an exhaust fan) and/or a gas controller (for example, a fluid meter, a valve or a switch).

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a high concentration H₂S elimination system according to Embodiment 1 of the present invention;

FIG. 2 is a perspective view of a high concentration H₂S elimination system according to Embodiment 2 of the present invention;

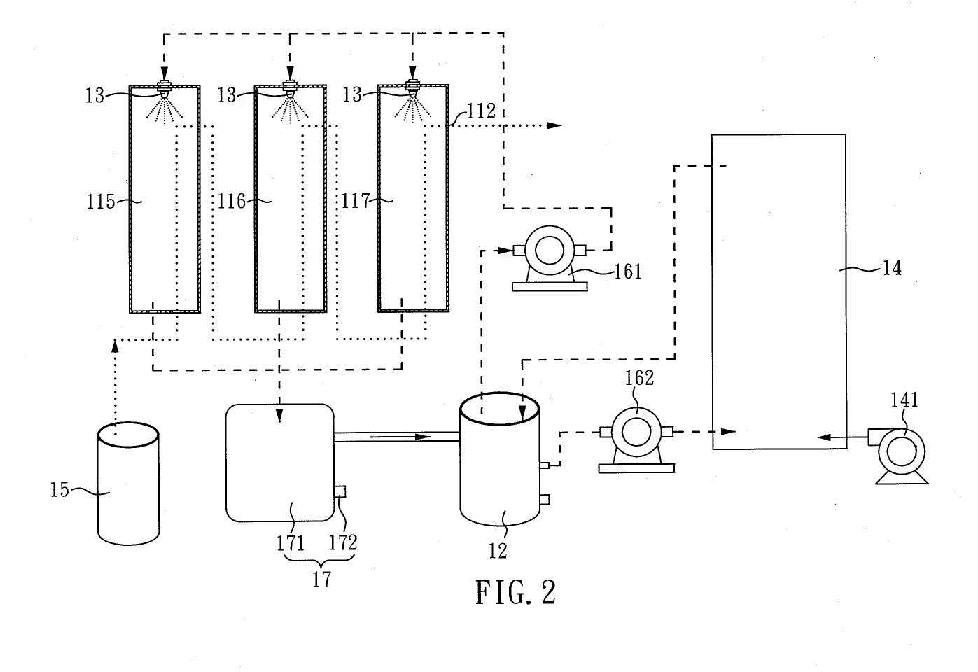

FIG. 3 is a diagram showing a H₂S-removing result in Testing Example of the present invention;

FIG. 4 is a diagram showing a H₂S-removing result in Testing Example of the present invention; and

FIG. 5 is a diagram showing the change of the cell number in Testing Example of the present invention.

### DETAILED DESCRIPTION OF THE PREFERRED EMBODIMENT

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

The accompanied figures according to the following embodiments of the present invention are perspective views, and only the devices or components related to the present invention are shown therein. It should be noted that the actual performing aspects of the devices or components are not shown in the figure. The number, the shape and the size thereof can be selectively designed, and may be more complicated based on the performance requirements.

### Embodiment 1

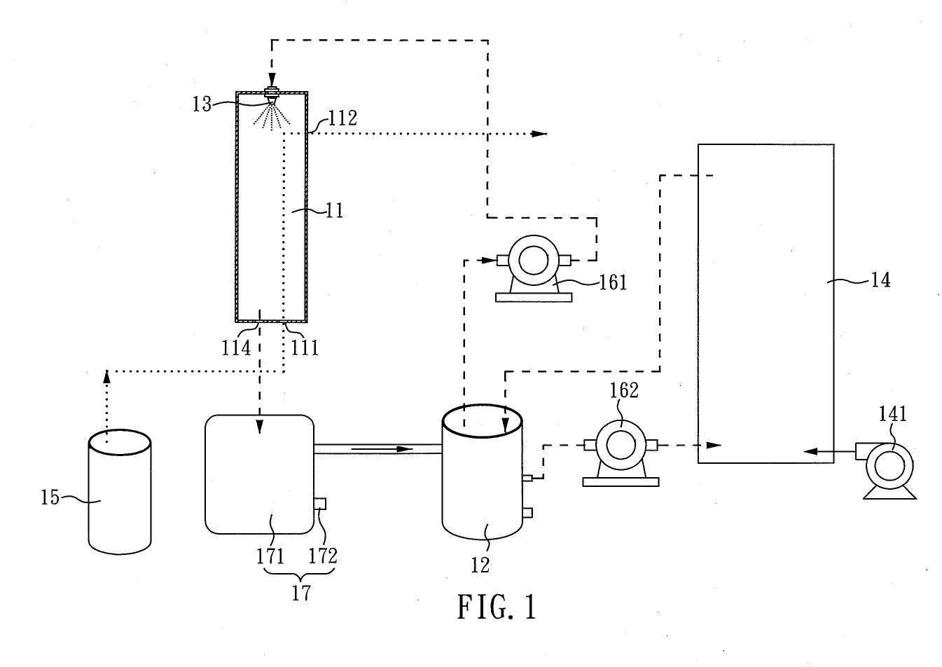

FIG. 1 is a perspective view of a high concentration H₂S elimination system of the present embodiment, wherein the symbol “- - - ” indicates the liquid flow path, and the symbol “. . . ” indicates the gas flow path. In the present embodiment and the following embodiments, the liquid flow path and the gas flow path are only indicated with lines. However, the liquid and gas flow paths can be formed by pipes such as plastic pipes, metal tubes, stainless tubes, or pipes or tubes made of other materials.

As shown in FIG. 1, the high concentration H₂S elimination system of the present embodiment comprises: a chemical H₂S elimination module 11 comprising one H₂S elimination column and having a gas inlet 111, a gas outlet 112 and a liquid outlet 114, wherein H₂S-containing gas 15 is introduced into the chemical H₂S elimination module 11 from the gas inlet 111; a reagent storage unit 12 containing an oxidant and connecting to the liquid outlet 114 of the chemical H₂S elimination module 11; a liquid spray unit 13, wherein the oxidant contained in the reagent storage unit 12 is introduced into the chemical H₂S elimination module 11 through the liquid spray unit 13; a bio-regeneration unit 14 comprising an organism to regenerate a reduced reagent into the oxidant and connecting to the reagent storage unit 12; and a sulfur-removing module 17 disposed between the chemical H₂S elimination module 11 and the reagent storage unit 12.

In order to facilitate the flowing of the liquid, pumps 161, 162 are respectively disposed between the reagent storage unit 12 and liquid spray unit 13, and between the reagent storage unit 12 and the bio-regeneration unit 14.

Furthermore, in order to remove sulfur solids, the sulfur-removing module 17 of the present embodiment further comprises: a sulfur filtration unit 171, and a sulfur-removing unit 172.

In the present invention, the oxidant is a Fe³⁺-containing solution, and the organism to regenerate the oxidant is Acidithiobacillus ferrooxidans.

Hereinafter, the operation of the high concentration H₂S elimination system of the present embodiment is described in detail. As shown in FIG. 1, the H₂S-containing gas 15 is introduced into the chemical H₂S elimination module 11 from the gas inlet 111 thereof, and the oxidant contained in a reagent storage unit 12 is introduced into the chemical H₂S elimination module 11 from the top end thereof with the liquid spray unit 13 via the pump 161. The H₂S contained in the H₂S-containing gas 15 introduced into the chemical H₂S elimination module 11 reacts with the sprayed oxidant to obtain a reduced reagent and H₂S-removing gas. Herein, the H₂S-removing gas is exhausted from the top end of the chemical H₂S elimination module, and the reduced reagent is exhausted into a sulfur-removing module 17 through the liquid outlet 114 of the chemical H₂S elimination module 11. The sulfur solids are separated from the reduced reagent by the sulfur filtration unit 171 of the sulfur-removing module 7 via a precipitation means or an interception means, and the separated sulfur solids are removed from the system via the sulfur-removing unit 172. Then, the reduced reagent substantively without the sulfur solids is firstly introduced into the reagent storage unit 12, and then into the bio-regeneration unit 14 by the pump 162. The organism contained in the bio-regeneration unit 14 can oxidize the introduced reduced reagent into the oxidant in the original oxidation state. Then, the oxidant regenerated by the organism is introduced back into the reagent storage unit 12 to recycle the oxidant. In addition, the high concentration H₂S elimination system of the present embodiment further comprises a gas compressor 141 to provide gas into the bio-regeneration unit 14, in order to ensure the survival and the function of the organism in the bio-regeneration unit 14.

### Embodiment 2

The high concentration H₂S elimination system and the method operating the same of the present embodiment are similar to those described in Embodiment 1, except for the following differences.

In the high concentration H₂S elimination system of the present embodiment, the chemical H₂S elimination module comprises plural H₂S elimination columns 115, 116, 117 connecting with each other in series. In the present embodiment, the series connection of the H₂S elimination columns 115, 116, 117 means that the gas sequentially flows through the H₂S elimination columns 115, the H₂S elimination columns 116 and the H₂S elimination columns 117.

In addition, in the high concentration H₂S elimination system of the present embodiment, the top end of each H₂S elimination column 115, 116, 117 is respectively provided with a liquid spray unit 13, and the pump 161 introduces the oxidant in the reagent storage unit 12 to each liquid spray unit 13 to spray the oxidant into each H₂S elimination column 115, 116, 117 respectively.

### TESTING EXAMPLE

The high concentration H₂S elimination system of Embodiment 1 is used in the present testing example. The organism to regenerate the oxidant was Acidithiobacillus ferrooxidans CP9 (GenBank No. EF605251); the oxidant was a Fe³⁺-containing solution; and the H₂S elimination column was an empty tank (25 cm c (diameter)×160 cm H (length)).

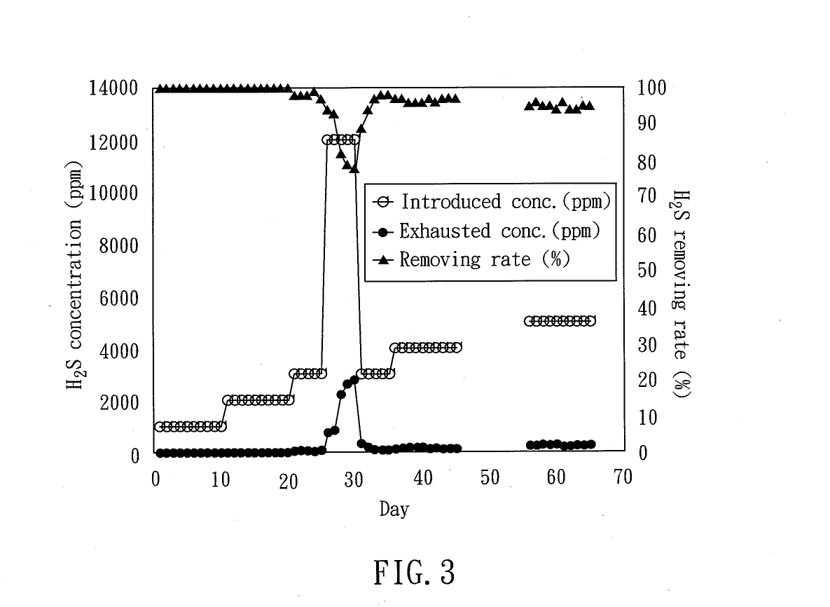

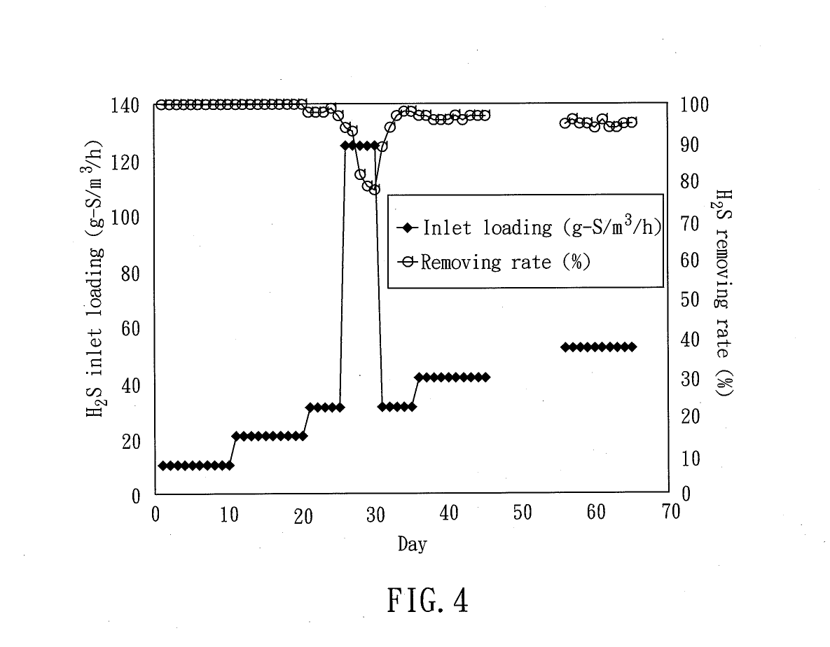

Herein, high concentration H₂S gas was mixed with air to the final concentration of 1000, 2000, 3000, 4000 and 5000 ppm, and the flow rate of H₂S-containing gas was 10 LPM. It was estimated that the inlet loading (i.e. the inlet amount of H₂S per time and per volume unit) of the H₂S-containing gas in the present example was about 10, 20, 30, 40 and 50 g−S/m³/h. The test was performed several days, and 3 hr in each test (day). In addition, the shock loading test was performed at Day. 25-30, in which the concentration of H₂S in the H₂S-containing gas was increased from 3000 ppm to 12000 ppm, and reduced back to 3000 ppm after 5 days. The inlet loading of the H₂S-containing gas used in the shock loading test was about 130 g−S/m³/h. Furthermore, the shut-down test was performed at Day 46-55, and then the concentration of H₂S in the H₂S-containing gas increased to 5000 ppm at Day 56-65. The results were shown in FIG. 3 and FIG. 4, wherein the term “introduced conc.” in FIG. 3 indicates the introduced concentration of H₂S in the H₂S-containing gas, and the term “exhausted conc.” in FIG. 3 indicates the exhausted concentration of H₂S in the H₂S-removing gas.

As shown in FIG. 3, the removing rate of H₂S was almost 100% when the introduced concentration of H₂S in the H₂S-containing gas was about 1000-2000 ppm; the removing rate of H₂S was almost 97% when the introduced concentration of H₂S was about 3000-4000 ppm; the removing rate of H₂S was almost 95% when the introduced concentration of H₂S was about 5000 ppm; and the removing rate of H₂S was almost 80% even though the introduced concentration of H₂S was about 12000 ppm.

As shown in FIG. 4, when the inlet loading of the H₂S-containing gas was about 10 g−S/m³/h to about 50 g−S/m³/h, the removing rate of H₂S was almost 95% and more. Even though the inlet loading thereof was about 130 g−S/m³/h, the removing rate was about 80%.

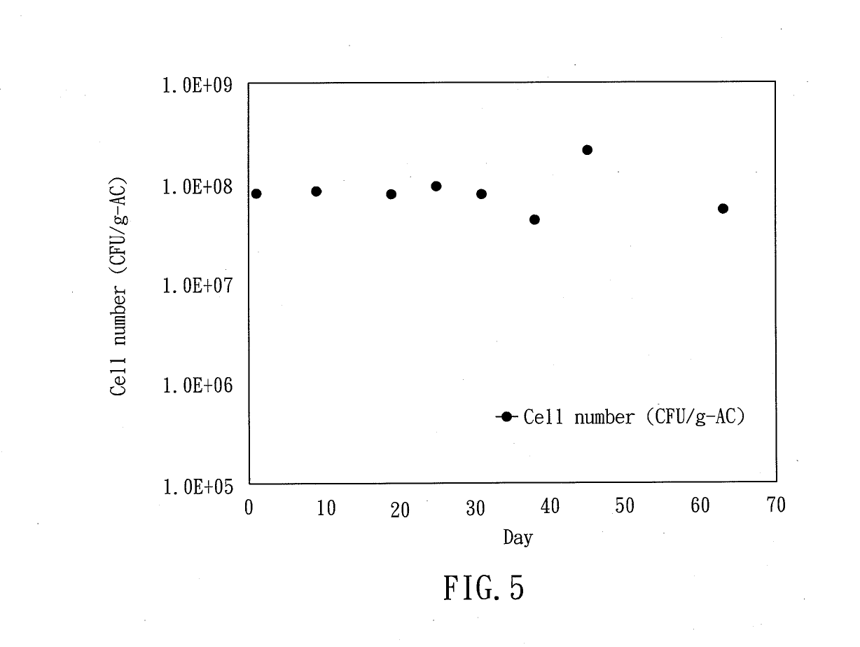

In addition, the cell number of the organism in the bio-regeneration unit was also examined in the present testing example. As shown in FIG. 5, during the whole testing period, the cell number of the organism was not changed significantly, and increased from 7.9×10⁷ CFU/g-GAC to 2.1×10⁸ CFU/g-GAC. This result indicates that the bio-regeneration unit in the high concentration H₂S elimination system of the present invention has excellent stability and performance effect, and can be used for the regeneration of the oxidant over a long period of time.

According to the aforementioned result, the high concentration H₂S elimination system of the present invention is highly suitable for treating high concentration H₂S-containing gas. In addition, according to the result of the shock loading test, exceeding inlet loading of H₂S did not cause long-term influence on the system of the present invention, and regular H₂S-removing effect of the system can be returned in a short time. Furthermore, according to the result of the shut-down test, the shutdown of the system does not influence the sequential performance effect of the system of the present invention.

Although the present invention has been explained in relation to its preferred embodiment, it is to be understood that many other possible modifications and variations can be made without departing from the spirit and scope of the invention as hereinafter claimed.

What is claimed is:

1. A high concentration H₂S elimination system, comprising:
a chemical H₂S elimination module with a gas inlet, a gas outlet and a liquid outlet, wherein H₂S-containing gas is introduced into the chemical H₂S elimination module from the gas inlet;
a reagent storage unit containing an oxidant, which is a Fe³⁺-containing solution, a Mn⁴⁺-containing solution, or a combination thereof;
a liquid spray unit, wherein the oxidant contained in the reagent storage unit is introduced into the chemical H₂S elimination module from the liquid inlet thereof through the liquid spray unit;
a bio-regeneration unit comprising an organism to regenerate a reduced reagent into the oxidant and connecting to the reagent storage unit; and
a sulfur-removing module connecting to the liquid outlet of the chemical H₂S elimination module.

2. The high concentration H₂S elimination system as claimed in claim 1, wherein the sulfur-removing module is disposed between the chemical H₂S elimination module and the reagent storage unit.

3. The high concentration H₂S elimination system as claimed in claim 1, wherein the sulfur-removing module comprises: a sulfur filtration unit, and a sulfur-removing unit.

4. The high concentration H₂S elimination system as claimed in claim 1, wherein the chemical H₂S elimination module comprises: at least one H₂S elimination column.

5. The high concentration H₂S elimination system as claimed in claim 1, wherein the chemical H₂S elimination module comprises: plural H₂S elimination columns connecting with each other in series or in parallel.

6. The high concentration H₂S elimination system as claimed in claim 1, wherein the organism is a microorganism or an enzyme which is capable of regenerating the reduced reagent into the oxidant.

7. The high concentration H₂S elimination system as claimed in claim 1, wherein the bio-regeneration unit further comprises: a liquid medium with the organism suspending therein; or a support with the organism adhered thereon or embedded therein.

8. The high concentration H₂S elimination system as claimed in claim 1, wherein a concentration of H₂S in the H₂S-containing gas is 1000 ppm or more.

9. A method for eliminating high concentration H₂S gas, comprising the following steps:
(A) introducing H₂S-containing gas into a chemical H₂S elimination module, and introducing an oxidant contained in a reagent storage unit into the chemical H₂S elimination module with a liquid spray unit to react H₂S in the H₂S-containing gas with the oxidant to obtain a reduced reagent and H₂S-removing gas, wherein the H₂S-removing gas is exhausted from the chemical H₂S elimination module, the reduced reagent is exhausted into a sulfur-removing module or exhausted into a reagent storage unit and then introduced into the sulfur-removing module, and the oxidant is a Fe³⁺-containing solution, a Mn⁴⁺-containing solution, or a combination thereof;
(B) removing sulfur solids in the reduced reagent via the sulfur-removing module, and then introducing the reduced reagent without the sulfur solids into a bio-regeneration unit, wherein the bio-regeneration unit comprises an organism to regenerate the reduced reagent without the sulfur solids into the oxidant; and
(C) recycling and introducing the oxidant regenerated by the organism into the reagent storage unit.

10. The method as claimed in claim 9, wherein the sulfur-removing module comprises a sulfur filtration unit and a sulfur-removing unit, the sulfur solids are separated from the reduced reagent by the sulfur filtration unit and removed by the sulfur-removing unit.

11. The method as claimed in claim 9, wherein the chemical H₂S elimination module comprises at least one H₂S elimination column.

12. The method as claimed in claim 9, wherein the chemical H₂S elimination module comprises: plural H₂S elimination columns connecting with each other in series or in parallel.

13. The method as claimed in claim 9, wherein the organism is a microorganism or an enzyme which is capable of regenerating the reduced reagent into the oxidant.

14. The method as claimed in claim 9, wherein the bio-regeneration unit further comprises: a liquid medium with the organism suspending therein; or a support with the organism adhered thereon or embedded therein.

15. The method as claimed in claim 9, wherein a concentration of the H₂S in the H₂S-containing gas is 1000 ppm or more.
